(19) United States
(12) Patent Application Publication
(10) Pub. No.: US 2023/0135435 A1
(43) Pub. Date: May 4, 2023

(54) THERMOFORMABLE NONWOVEN COMPOSITE

(71) Applicant: Milliken & Company, Spartanburg, SC (US)

(72) Inventors: Kazuaki Shibata, Simpsonville, SC (US); Mark Mapes, Pelzer, SC (US)

(21) Appl. No.: 17/974,165

(22) Filed: Oct. 26, 2022

Related U.S. Application Data
(60) Provisional application No. 63/274,740, filed on Nov. 2, 2021.

(51) Int. Cl. B29C 51/00; D04H 1/55; D04H 1/541; D04H 1/488; B29C 51/42; D06M 15/507; D04H 1/435; D04H 1/74

(52) U.S. Cl. CPC B29C 51/004; D04H 1/55; D04H 1/5412; D04H 1/488; B29C 51/421; D06M 15/507; D04H 1/435; D04H 1/5418; D04H 1/74; D06M 2200/12; B29K 2713/00; B29K 2995/0093; B29K 2995/0072; B29K 2667/00

(57) ABSTRACT

A thermoformable nonwoven composite containing a nonwoven layer which contains a plurality of first staple fibers, a plurality of first binder fibers having a first melting point, and a plurality of second binder fibers having a second melting point, wherein the first staple fibers, first binder fibers, and second binder fibers intertwine and cross at crossover points. The difference first melting point and the second melting point differ by at least about 15° C., and at least 95% by weight of all of the fibers in the nonwoven layer are polyester. The thermoformable nonwoven composite also contains a first resin formulation containing a first resin. The first resin is located within the nonwoven and located in at least a portion of the crossover points. The first staple fibers, the first and second binder fibers, and the first resin all contain a polymer from the same chemical class.

### RELATED APPLICATIONS

This application claims priority to Provisional Patent Application 63/274,740 filed on Nov. 2, 2021, which is herein incorporated by reference.

### TECHNICAL FIELD OF THE INVENTION

The invention provides a moldable nonwoven composite and a thermoformed nonwoven having good physical properties.

### BACKGROUND

There are a number of products in various industries, including automotive, office and home furnishings, construction, and others; that require materials having a z-direction thickness to provide both structural strength as well as thermal, sound insulation, aesthetic, and/or other performance features. In many of these applications it is also required that the material be thermoformable to a specified shape and rigidity. In the automotive industry these products often are used for shielding applications such as noise and thermal barriers in automotive hood liners, underbody shields, firewall barriers, and trunk liners.

Composite materials used in automotive applications like package shelves, door panels or headliners are often produced via heating and then cold pressing structural nonwoven composite layers bound by a thermoplastic binder fiber to a decorative layer.

It would be preferably to be able to create an easy to manufacture and use composite that used thermoplastic materials and would be more recyclable than other products currently in the marketplace.

### BRIEF SUMMARY OF THE INVENTION

The invention relates to a thermoformable nonwoven composite having a first side and a second side and containing a nonwoven layer. The nonwoven layer contains a plurality of first staple fibers, a plurality of first binder fibers having a first melting point, and a plurality of second binder fibers having a second melting point, wherein the first staple fibers, first binder fibers, and second binder fibers intertwine and cross at crossover points. The difference between the first melting point and the second melting point differ by at least about 15° C., and at least 95% by weight of all of the fibers in the nonwoven layer are polyester.

The thermoformable nonwoven composite also contains a first resin formulation containing a first resin. The first resin is located within the nonwoven and located in at least a portion of the crossover points. The first staple fibers, the first binder fibers, the second binder fibers, and the first resin all contain a polymer from the same chemical class.

The invention also relates to process of forming a thermoformable nonwoven composite having a first side and a second side. The process includes the step of carding, cross lapping, needle punching a plurality of first staple fibers, a plurality of first binder fibers, and a plurality of second binder fibers forming a nonwoven, where the first staple fibers, the first binder fibers, and the second binder fibers intertwine and cross at crossover points. The process also includes the steps of forming an aqueous coating composition containing a first resin, applying the coating composition to the nonwoven forming a coated nonwoven, and applying heat to the coated nonwoven to at least partially removing the water forming the thermoformable nonwoven composite.

### BRIEF DESCRIPTION OF THE FIGURES

An embodiment of the present invention will now be described by way of example, with reference to the accompanying drawings.

FIG. 1 illustrates schematically a cross-section of one embodiment of the moldable nonwoven composite.

FIG. 2 illustrates schematically a cross-section of an enlarged section of the thermoformable nonwoven composite of FIG. 1.

### DETAILED DESCRIPTION OF THE INVENTION

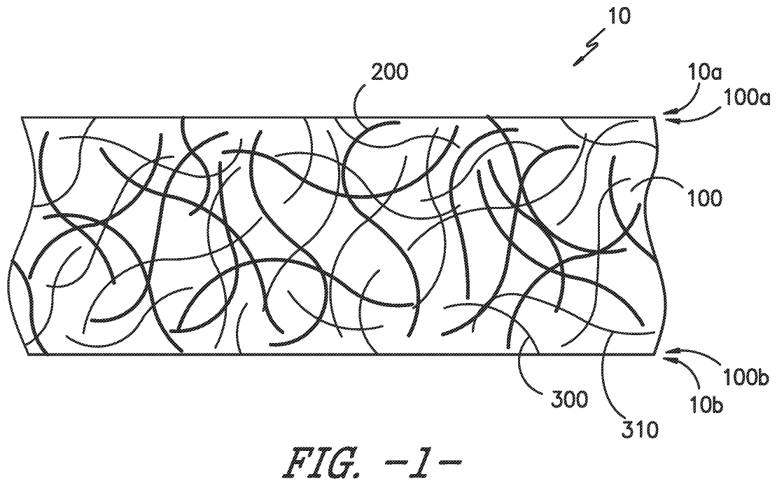

Referring to FIG. 1, there is shown one embodiment of a thermoformable nonwoven composite 10 having a first side 10a and a second side 10b. The thermoformable nonwoven composite 10 contains a nonwoven layer 100 having a first side 100a, a second side 100b. In one embodiment, the first side 100a of the nonwoven layer 100 forms the first side 10a of the composite 10. In one embodiment, the second side 100b of the nonwoven layer 100 forms the second side 10b of the composite 10. The nonwoven layer 100 is a unitary material made as one nonwoven layer, not two or more layers that are adhered or otherwise connected together. Once the thermoformable nonwoven composite 10 is molded under heat and pressure, it becomes a molded composite.

In one embodiment, the thickness of the nonwoven layer 100 is between about 2 mm and 10 mm, more preferably between about 3 mm and 7 mm. The thickness is defined as the distance between the first side 100a and the second sided 100b of the nonwoven layer 100. In one embodiment, the areal weight of the thermoformable nonwoven composite 10 is between about 500 and 1600 g/m², more preferably between about 700 and 1200 g/m².

The process to form a thermoformable nonwoven composite 10 begins with forming the nonwoven layer 100 comprising a plurality of first staple fibers 200, first binder fibers 300, and second binder fibers 310. The nonwoven layer 100 is formed by the steps of blending, carding, cross-lapping, and needle punching the plurality of first staple fibers 200 and binder fibers 300/310. In one embodiment, the nonwoven layer is needled from the first side and the second side of the layer. The first staple fibers 200 and binder fibers 300/310 may be located within the nonwoven layer in a generally uniform way or may be stratified meaning that the concentration of a particular fiber is higher on the first side 100a or second side 100b.

The nonwoven layer comprises a plurality of first staple fibers 200. Some examples of suitable first staple fibers include glass fibers, aramid fibers, and highly oriented polypropylene fibers, bast fibers, polyester fibers, and carbon fibers.

The first staple fibers provide volume, reinforcement, and strength to the nonwoven layer 100 and composite 10. Additional examples of first staple fibers 200 would include fibers with high denier per filament (one denier per filament or larger), high crimp fibers, hollow-fill fibers, and the like. These fibers provide mass and volume to the material. Some examples of first staple fibers include polyester, polypropylene, and cotton, as well as other low cost fibers.

In one embodiment, the first staple fibers 200 may include fibers made from highly oriented polymers, such as gel-spun ultrahigh molecular weight polyethylene fibers (e.g., SPECTRA™ fibers from Honeywell Advanced Fibers of Morristown, N.J. and DYNEEMA™ fibers from DSM High Performance Fibers Co. of the Netherlands), melt-spun polyethylene fibers (e.g., CERTRAN™ fibers from Celanese Fibers of Charlotte, N.C.), melt-spun nylon fibers (e.g., high tenacity type nylon 6,6 fibers from Invista of Wichita, Kans.), melt-spun polyester fibers (e.g., high tenacity type polyethylene terephthalate fibers from Invista of Wichita, Kans.), and sintered polyethylene fibers (e.g., TENSYLON™ fibers from ITS of Charlotte, N.C.). Suitable first staple fibers also include those made from rigid-rod polymers, such as lyotropic rigid-rod polymers, heterocyclic rigid-rod polymers, and thermotropic liquid-crystalline polymers.

The nonwoven layer 100, in another embodiment, contains a plurality of second staple fibers. These second staple fibers may be selected from the same listing of materials as the first staple fibers. The second staple fibers may be the same or different from the first staple fibers in the materials, denier, staple length, melting or tensile properties, cross-section shape, or any other characteristic. In a preferred embodiment, the second staple fibers contain the same material as first staple fibers, such as polyester, to increase the recyclability of the composite 10.

The nonwoven layer 100 also contains a plurality of first binder fibers 300. Binder fibers are defined to be fibers that form an adhesion or bond with the other fibers. In one embodiment, the first binder preferably are fibers that are heat activated. Examples of heat activated binder fibers are fibers that can melt at lower temperatures, such as low melt fibers, bi-component fibers, such as side-by-side or core and sheath fibers with a lower sheath melting temperature, and the like.

In one embodiment, the first binder fibers are bi-component fibers containing at least 2 components (they may contain 3 or more). In one embodiment, the bi-component fibers awe a core/sheath fiber meaning the fibers contain a core comprising a core polymer and a sheath comprising a sheath polymer. The core polymer has a higher melting temperature than the sheath polymer. In one embodiment, the core polymer has a melting temperature of at least about 180° C. and the sheath polymer has a melting temperature of less than about 180° C. In another embodiment, the core polymer has a melting temperature of at least about 180° C. and the sheath polymer has a melting temperature of less than about 160° C. Preferably, the core/sheath fibers have a core polymer of polyester and a sheath polymer of a different polyester such that the core and sheath polymers meet the melting temperature limitations.

The first binder fibers are preferably staple fibers. In one embodiment, after molding under heat and pressure, the binder fibers are still discernable fibers with the sheath and core at least partially intact. In another embodiment, the core of the core/sheath fibers remains intact, but the sheath of the core/sheath fibers lose the fiber shape and form a coating on surrounding material. In another embodiment, binder fibers almost completely lose their fiber shape and form a coating on surrounding materials (when consolidated).

The nonwoven layer 100, in another embodiment, contains a plurality of second binder fibers 310. These second binder fibers 310 may be selected from the same listing of materials as the first binder fibers. The second binder fibers may be the same or different from the first binder fibers in the materials, denier, staple length, melting or tensile properties, cross-section shape, or any other characteristic. In a preferred embodiment, the second binder fibers contain the same material as first binder fibers, such as polyester, to increase the recyclability of the composite 10, but vary in melting temperature. In one preferred embodiment, the melting temperature of the first binder fibers is at least about 15° C., more preferable at least about 30° C., more preferably at least about 50° C. greater than the melting temperature of the second binder fibers 310. In another embodiment, the melting temperature of the first binder fibers is between 15 and 130° C., more preferable between 30 and 120° C., greater than the melting temperature of the second binder fibers 310.

When the nonwoven layer 100 contains both a plurality of first binder fibers 300 and second binder fibers, preferably the melting temperature difference between the two types of fibers is at least about 15, more preferably at least about 50. The ratio, by weight, of the first binder fibers to the second binder fibers is preferably about 5 to 25.

In one embodiment, at least a portion of the first staple fibers and/or the first binder fibers are coated with a hydrophobic coating. In one embodiment, a non-fluorinated based water repelling agent may be sprayed onto fibers before carding to give waterproof/ice detach performance when the article is in use. By spraying resin onto the fibers before carding, the resin is able to transfer and distribute evenly to give a uniform water-proof property. In one embodiment, at least a portion of the fibers are treated to have a water repellent or waterproof property. This may be applied separately to the fibers, yarns, and/or formed fabric and in one embodiment may be part of the first resin. These water repellent or waterproof chemistries may contain fluorochemicals or preferably are non-fluorine based to be more environmentally friendly.

As the nonwoven layer 100 is formed using any suitable method of forming staple fibers into a nonwoven layer (before the introduction of the first resin), the % by weight ratios of first staple fibers to all binder fibers within the layer is between about 50:50 to 90:10, more preferably between about 60:40 to 75:25. Before the introduction of the first resin, the nonwoven layer preferably comprises between about 10 and 50% by weight of binder fibers (including all types of binder fibers), more preferably between about 25 and 40%. As the nonwoven layer is formed (before the introduction of the first resin), the nonwoven layer preferably comprises between about 50 and 95% by weight of first staple fibers, more preferably between about 30 and 60%. All of the fibers within the layer 100 (first staple fibers, optional second staple fibers, first binder fibers, optional second binder fibers, etc) intertwine and cross at crossover points.

After the nonwoven layer 100 is formed, it is at least partially impregnated with a first resin. The first resin is located within the nonwoven and located in at least a portion of the crossover points. In a preferred embodiment, the first resin is a thermoplastic resin, meaning that the resin is a polymer with a melting temperature.

In one embodiment, the first staple fibers, first binder fibers, and first resin all comprise a polymer from the same chemical class. In another embodiment, all of the fibers and resins in the composite 10 contain a polymer from the same chemical class. Monomaterial compositions (material comprising the same polymer type) tend to eliminate chemical compatibility/bonding issues. In addition, constructions using the same material type can be more easily recycled and reused at end of life. In a preferred embodiment the material used in the fibers and resins is polyester. Polyester is preferred for some embodiments as it has a high melt point as well as durability. Recycled polymer material may also be used for some end products to help make the product more environmentally friendly. In another embodiment the material used in the fibers and resins is polyamide. In one preferred embodiment, essentially all (meaning at least about 95% by weight) of the fibers in the composite are polyester.

Aqueous based resins are preferred over solvent based resin systems for environmental reasons and higher costs associated with solvent handling and recovery. The aqueous resins are infused, coated, sprayed, dipped, or introduced into the layer 100 by any suitable means. After the first resin is added to the nonwoven fibers, the water is at least partially removed (preferably by drying using ambient or heated air). This forms the thermoformable nonwoven composite 10. This drying step, in addition to removing some or all of the water from the first resin, may also preferably at least partially melt the first (and optionally second) binder fibers. This at least partial melting of the binder fibers activates them to adhere the composite 10 together so that the composite can be more easily be handled and transported. The drying occurs such that the temperature at the center of the composite 10 is less than about 150° C., more preferably less than about 110° C. Keeping the temperature at the center below this temperature may important so as not to melt or cure the resin (in some embodiments) at this step. Preferably, the drying of the wet nonwoven layer results in removing between about 90 and 95% by weight of the water from the water-based thermoplastic resin.

Preferably, the drying of the wet nonwoven layer comprises using superheated steam. Steam has a higher heat capacity than air and is therefore naturally a better heating medium. The problem with steam is that it must remain above a certain temperature, or it will start to condense back into water. This is problematic in drying, because moisture pulled from the material naturally cools the heating medium. So if saturated steam were to be used, it would quickly condense and rain in the drum, because steam is so close to the temperature at which it condenses. This problem is avoided by using superheated steam as the drying medium. Superheated steam also allows for the impregnated structural nonwoven to be dried without initiating cross-linking/curing of the resin.

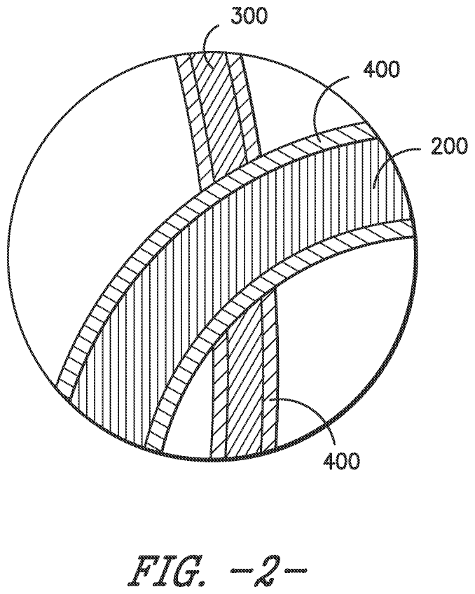

The resin 400 is not shown in FIG. 1 due to the difficulty showing such a thin coating on the fibers 200, 300. FIG. 2 is an enlargement of a section of the cross-section of FIG. 1 where the coating of the water-based thermosetting resin 400 can be seen on the fibers 200, 300. The coating may be so thin that in some embodiments, the coating may only be present at the fiber crossover locations instead of showing up as a true coating. After the majority of the water is driven off, the thermoformable nonwoven composite comprises between about 1 and 20% by weight resin, more preferably between about 5 and 15% by weight resin. In one embodiment, the different materials in the composite may be: first staple fibers: 50-75% by weight, first binder fibers (110° C. Tm): 20-40% by weight, second binder fibers (180° C. Tm): 7-20% by weight, and first resin: 2-12% by weight.

This composite differs from some other thermoplastic resin and fiber composites where the resin is the continuous component with some fibers suspended in the resin. In this thermoformable nonwoven composite, the majority of the composite is fibers with the resin forming a coating on the fibers. Preferably, the resin is not continuous throughout the composite 10.

The thermoformable nonwoven composite 10 is preferably still flexible. This means that the thermoformable nonwoven composite 10 is able to be completely folded onto itself (a 180 degree fold) and then can be unfolded without any permanent changes in appearance or physical properties. This flexibility is important for the composite to be used in certain applications like in molded parts for cars.

Next, the thermoformable nonwoven composite 10 may be cut into a desired shape and size and the molded. To form the thermoformable nonwoven composite 10 into a molded composite, heat and optionally pressure is applied to the thermoformable nonwoven composite 10 heating the composite to a temperature of at least about 160° C. (measured at the inner plane of the structural nonwoven layer) this serves to melt or cure the resin. Preferably in another embodiment, the composite is brought to a temperature of greater than about 180° C. to ensure that both binder fibers (first and second) are melted and will help adhere and stabilize the composite. This melts at least partially melts the first binder fibers and melts the first resin bonding at least a portion of the first staple fibers to other first staple fibers. In one embodiment, the curing causes at least a portion of the first resin to at least partially coalesce.

In the molded composite, at least a portion of the binder fibers may still have a fibrous shape with the other fibers melting into binder material (the binder material typically coating the first staple fibers or forming adhesive blobs).

In the embodiment where the first binder fibers are bi-component fibers containing a core and sheath, preferably the sheath of the fibers melts while the core of the fibers remains (in a fibrous form). Preferably, the sheath polymer and thermoplastic resin bond at least a portion of the first staple fibers to other first staple fibers, at least a portion of the first staple fibers to the core of the bi-component fibers, and least a portion of the cores of the bi-component fibers to other cores of the bi-component fibers.

The molded nonwoven composite preferably becomes more rigid (also referred to as less flexible) than the thermoformable nonwoven composite. Preferably, the molded nonwoven composite is stiff enough to support its own weight, hold its own shape, and may even be stiff enough to support additional weight without changing its shape. In one embodiment, the molded nonwoven composite has a maximum flexural bending strength at least 20N.

In one embodiment, the thermoformable nonwoven composite 10 (and the molded composite) contains additional fibers. The additional fibers may be uniformly distributed throughout the nonwoven layer 100 or may have a stratified concentration. These additional fibers may include, but are not limited to additional binder fibers having a different denier, staple length, composition, or melting point, additional bulking fibers having a different denier, staple length, or composition, and an effect fiber, providing benefit a desired aesthetic or function. These effect fibers may be used to impart color, chemical resistance (such as polyphenylene sulfide fibers and polytetrafluoroethylene fibers), moisture resistance (such as polytetrafluoroethylene fibers and topically treated polymer fibers), or others.

In one embodiment, the additional fibers may be heat and flame resistant fibers, which are defined as fibers having a Limiting Oxygen Index (LOI) value of 20.95 or greater, as determined by ISO 4589-1. Examples of heat and flame resistant fibers include, but are not limited to the following: fibers including oxidized polyacrylonitrile, aramid, or polyimide, flame resistant treated fibers, FR rayon, carbon fibers, or the like. These heat and flame resistant fibers may also act as the bulking fibers or may be used in addition to the bulking fibers.

All of the fibers within the thermoformable nonwoven composite 10 (and the molded composite) may optionally contain additives. Suitable additives include, but are not limited to, fillers, stabilizers, plasticizers, tackifiers, flow control agents, cure rate retarders, adhesion promoters (for example, silanes and titanates), adjuvants, impact modifiers, expandable microspheres, thermally conductive particles, electrically conductive particles, silica, glass, clay, talc, pigments, colorants, glass beads or bubbles, antioxidants, optical brighteners, antimicrobial agents, surfactants, fire retardants, and fluoropolymers. One or more of the above-described additives may be used to reduce the weight and/or cost of the resulting fiber and layer, adjust viscosity, or modify the thermal properties of the fiber or confer a range of physical properties derived from the physical property activity of the additive including electrical, optical, density-related, liquid barrier or adhesive tack related properties.

In one embodiment, the thermoformable nonwoven composite (and the molded composite) does not contain any fluorinated chemistry. This is defined to mean that the composite as a whole contains less than 0.01% by weight fluorinated chemistry. In another embodiment, the thermoformable nonwoven composite (and the molded composite) does not contain any glass fibers. This is defined to mean that the composite as a whole contains less than 0.01% by weight glass. Glass and fluorinated chemistries are not preferred in some applications due to their environmental impacts and the difficulty to recycle them.

In one embodiment, the thermoformable nonwoven composite 10 (and the molded composite) may contain an additional nonwoven layer. The additional nonwoven layer may be exactly same as the nonwoven layer 100 or may have different fibers, densities, and ratios. The properties described in relation to the nonwoven layer 100 are applicable to the additional nonwoven layer. The additional nonwoven layer(s) may be attached to one or both sides of the nonwoven layer 100 by any suitable means such as needling or adhesives.

The composite 10 may also contain any additional layers for physical or aesthetic purposes. Suitable additional layers include, but are not limited to, a nonwoven fabric, a woven fabric, a knitted fabric, a foam layer, a film, a paper layer, an adhesive-backed layer, a foil, a mesh, an elastic fabric (i.e., any of the above-described woven, knitted or nonwoven fabrics having elastic properties), an apertured web, an adhesive-backed layer, or any combination thereof. Other suitable additional layers include, but are not limited to, a color-containing layer (e.g., a print layer); one or more additional sub-micron fiber layers having a distinct average fiber diameter and/or physical composition; one or more secondary fine fiber layers for additional insulation performance (such as a melt-blown web or a fiberglass fabric); foams; layers of particles; foil layers; films; decorative fabric layers; membranes (i.e., films with controlled permeability, such as dialysis membranes, reverse osmosis membranes, etc.); netting; mesh; wiring and tubing networks (i.e., layers of wires for conveying electricity or groups of tubes/pipes for conveying various fluids, such as wiring networks for heating blankets, and tubing networks for coolant flow through cooling blankets); or a combination thereof. The additional layers may be on either or both sides of the nonwoven composite. For example, a textile may be applied to one side of the nonwoven composite using an optional adhesive layer to form an aesthetic surface for an end use such as certain automobile applications.

The composite may further comprise one or more attachment devices to enable the composite to be attached to a substrate or other surface. In addition to adhesives, other attachment devices may be used such as mechanical fasteners like screws, nails, clips, staples, stitching, thread, hook and loop materials, etc.

The one or more attachment devices may be used to attach the composite to a variety of substrates. Exemplary substrates include, but are not limited to, a vehicle component; an interior of a vehicle (i.e., the passenger compartment, the motor compartment, the trunk, etc.); a wall of a building (i.e., interior wall surface or exterior wall surface); a ceiling of a building (i.e., interior ceiling surface or exterior ceiling surface); a building material for forming a wall or ceiling of a building (e.g., a ceiling tile, wood component, gypsum board, etc.); a room partition; a metal sheet; a glass substrate; a door; a window; a machinery component; an appliance component (i.e., interior appliance surface or exterior appliance surface); a surface of a pipe or hose; a computer or electronic component; a sound recording or reproduction device; a housing or case for an appliance, computer, etc. In another embodiment, the first side of the molded composite has lower surface roughness than the second side of the molded composite.

### EXAMPLE

The invention will now be described with reference to the following non-limiting examples, in which all parts and percentages are by weight unless otherwise indicated.

### Example 1

The nonwoven layer was formed from a blend of three fibers and had a basis weight of 1100 gram/m²:

1) 7% by weight of a 4 denier polyester core—180° C. co-polyester sheath fiber.

2) 28% by weight of 4 denier polyester core—110° C. co-polyester sheath fiber

3) 65% by weight of 6 denier polyester staple fiber

The fibers (before they were formed into the nonwoven layer) had a non-fluorinated based water repelling agent applied. The agent was in a 20% by weight aqueous solution and was applied in a weight of 1% weight of fiber ratio.

The nonwoven layer was produced using a standard industrial scale needle punch carpet production line. Staple fibers as indicated above were mixed and formed in a mat using carding and cross-lapping. The mat was pre-needled using plain barbed needles to form the nonwoven layers.

Once the above fibers were formed into a nonwoven, a first resin containing a polyester (PET) polymer was applied in a 5% weight of fiber ratio by spraying. The impregnated nonwoven composite was dried in a RF (radio frequency) oven. The dry add-on weight of the PET polymer was 5% (55 gsm) of the structural nonwoven layer.

### Example 2

Example 1 was consolidated using a heated platen press, with the platen temperatures set at 400° F. to melt the low-melt binder fibers and cross-link first resin. The cycle time was 90 seconds, and the consolidated nonwoven composite had a thickness of 4.0 mm. The application of heat and pressure allows the low-melt binder fiber and the first resin to bond the first staple fibers together.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A thermoformable nonwoven composite having a first side and a second side comprising:
a nonwoven layer comprising plurality of first staple fibers, a plurality of first binder fibers having a first melting point, and a plurality of second binder fibers having a second melting point, wherein the first staple fibers, first binder fibers, and second binder fibers intertwine and cross at crossover points, wherein the first melting point and the second melting point differ by at least about 15° C., and wherein at least 95% by weight of all of the fibers in the nonwoven layer are polyester; and, a first resin formulation comprising a first resin, wherein the first resin is located within the nonwoven and located in at least a portion of the crossover points, wherein the first staple fibers, the first binder fibers, the second binder fibers, and the first resin comprise a polymer from the same chemical class.

2. The thermoformable nonwoven composite of claim 1, wherein the first staple fibers, binder fibers, and the first resin comprise polyester.

3. The thermoformable nonwoven composite of claim 1, wherein the second binder fibers have a melting temperature lower than the melting temperature of the first binder fibers.

4. The thermoformable nonwoven composite of claim 1, wherein the first binder fibers are core/sheath fibers.

5. The thermoformable nonwoven composite of claim 1, wherein the first resin is a thermoplastic resin.

6. The thermoformable nonwoven composite of claim 1, wherein the first resin is a thermoset resin.

7. The thermoformable nonwoven composite of claim 1, wherein at least a portion of the first staple fibers and the first binder fibers comprise a hydrophobic coating.

8. The process of forming a thermoformable nonwoven composite having a first side and a second side comprising, in order:
carding, cross lapping, needle punching a plurality of first staple fibers, a plurality of first binder fibers, and a plurality of second binder fibers forming a nonwoven, wherein the first staple fibers, the first binder fibers, and the second binder fibers intertwine and cross at crossover points, wherein the first melting point and the second melting point differ by at least about 15° C., and wherein at least 95% by weight of all of the fibers in the nonwoven layer are polyester;
forming an aqueous coating composition comprising a first resin;
applying the coating composition to the nonwoven forming a coated nonwoven;
applying heat to the coated nonwoven to at least partially removing the water forming the thermoformable nonwoven composite.

9. The process of claim 8, wherein the coated nonwoven comprises between about 2 and 12% by weight of the dispersion coating composition.

10. The process of claim 8, wherein the first staple fibers and the first resin comprise polyester.

11. The process of claim 8, wherein the second binder fibers have a melting temperature lower than the melting temperature of the first binder fibers.

12. The process of claim 8, where applying heat at least partially melts the first binder fibers.

13. The process of claim 8, wherein the first resin is a thermoplastic resin and applying heat to the coated nonwoven causes first resin to at least partially coalesce.

14. The process of claim 8, wherein at least a portion of the first staple fibers and first binder fibers are coated with a hydrophobic coating before being carded, cross lapped, and needle punched into a nonwoven layer.

15. The process of forming a thermoformed nonwoven underbody shield comprising the process of forming a thermoformable nonwoven composite of claim 8, further comprising the step of placing the thermoformable nonwoven composite into a mold and applying heat to at least the first side of the thermoformable nonwoven composite and pressure forming the thermoformed nonwoven underbody shield, wherein the first side of thermoformed nonwoven underbody shield forms a skin and has a lower surface roughness than the second side of the thermoformed nonwoven underbody shield.

16. The process of claim 15, wherein the first and second sides of the thermoformed nonwoven underbody shield are more hydrophobic than the first and second sides of the thermoformable nonwoven composite.
